(19) United States
(12) Patent Application Publication
(10) Pub. No.: US 2019/0122056 A1
(43) Pub. Date: Apr. 25, 2019

(54) ULTRASONIC OBJECT DETECTION SYSTEM FOR MOTOR VEHICLES AND METHOD OF OPERATION THEREOF

(71) Applicant: MAGNA CLOSURES INC., Newmarket (CA)

(72) Inventors: Cuong TRAN, Mississuaga (CA); Allan CORNER, Aurora (CA); Liviu BOLBOCIANU, North York (CA)

(21) Appl. No.: 16/162,645

(22) Filed: Oct. 17, 2018

Related U.S. Application Data
(60) Provisional application No. 62/576,191, filed on Oct. 24, 2017.

(51) Int. Cl. G06K 9/00; G01H 5/00; G01S 7/521

(52) U.S. Cl. CPC G06K 9/00805; G01S 7/521; G01H 5/00

(57) ABSTRACT

An ultrasonic object detection system for a motor vehicle is provided. The system includes an indicator attached to a vehicle body for informing a user of an appropriate location to make an activation gesture for initiating opening of a closure member. At least one ultrasonic transducer is attached to the vehicle body. An electronic control unit is electrically coupled to the indicator and includes at least one ultrasonic driver electrically coupled to the at least one ultrasonic transducer. The electronic control unit is in communication with a plurality of vehicle controllers and is configured to receive a plurality of operational signals from the plurality of vehicle controllers, detect the activation gesture made by the user with the at least one ultrasonic transducer, and transmit an activation signal to the plurality of vehicle controllers in response to detecting the activation gesture made by the user for operating the closure member.

### CROSS-REFERENCE TO RELATED APPLICATIONS

This utility application claims the benefit of U.S. Provisional Application No. 62/576,191 filed Oct. 24, 2017. The entire disclosure of the above application is incorporated herein by reference.

### FIELD

The present disclosure relates generally to object detection systems for motor vehicles and, more particularly, to an object detection system for user-activation of a power closure member system to move a vehicle closure member relative to a vehicle body between a closed position and an open position.

### BACKGROUND

This section provides background information related to the present disclosure which is not necessarily prior art.

Motor vehicles, such as sports utility vehicles, can be designed to include a user-activated, non-contact power liftgate system for automatically opening a rear liftgate of the vehicle. The power liftgate system includes a sensor to detect motion of the user desiring to open the rear liftgate, for example a kicking motion of the user's foot beneath a rear bumper. The system includes technology to confirm the user, who is in possession of a key fob associated with the vehicle, is the source of the motion, so that the rear liftgate is not incorrectly activated, for example by another human, animal, weather conditions, or objects which could enter the space beneath the bumper. The system allows for convenient, user-friendly opening of the rear liftgate when the user's hands are occupied, for example when the user is holding items to be loaded in the vehicle.

Additionally, capacitive based sensor systems are currently being used to recognize foot gestures beneath the rear bumpers of vehicles to activate the opening of the rear liftgate. Capacitive sensing systems however have their limitations, and so use of ultrasonic sensors or transducers provides advantages over capacitive based systems. Typically, it is an objective to increase the foot detection area around a bumper of a vehicle, while minimizing the number of sensors required to increase this foot detection area. Fewer sensors covering an area translates into reduced component count, reduced system complexity, less visible sensor ports, and ultimately a lower cost sensing solution.

One drawback of employing ultrasonic sensors relates to the phenomenon known as “ringing”, which reduces the performance characteristics of the sensor (i.e. sensitivity, and minimum sensing distance). For example, ringing occurs when a sensor, having a membrane vibrated to generate a pulse/chirp, employs the same membrane to also receive the reflected pulse/chirp. Due to the speed at which the ultrasonic pulse travels to an object and is reflected back to the sensor membrane, the vibrating membrane does not have sufficient time to stabilize to a point where it can pick-up, or detect, the reflected signal (i.e. be induced to vibrate by the reflected wave). This means that in practice these sensors have to be placed at a sufficient distance (a minimum distance) from the ground or object to be detected to allow time for the sensor to stabilize to a point where it can properly detect reflected signals (i.e. be in a state where the vibrations of the membrane are induced by the reflected signal, and not residual vibrations of the transmit chirp/pulse). For example, such sensors are thus placed on vehicles having a certain height above the ground, such as SUVs, and trucks which inherently have a greater clearance between the body and the ground to allow for the membranes to settle before receiving reflected waves. Placing such sensors on cars, especially sports cars with a low ground clearance will not sufficiently position such sensors to be able to detect objects due to this ringing effect, since due to the short distance between the object and the sensor, reflected signals return to the sensor before the sensor has stabilized.

Another drawback is that ultrasonic sensors are typically baselined (reference distance) at the factory to a predetermined distance based on the vehicle being stationary on a flat surface, meaning that ultrasonic sensors are calibrated (i.e. detection algorithms based on certain reflection times parameter) assuming that the sensors remain at a height relative to the ground that is constant. That is, the baseline reference point for the system never changes, despite the possibility of the distance between the sensors positioned on the bumper and the ground changing depending on the road conditions in a non-factory and real-life environment. Thus, there is a need for improved object detection systems.

### SUMMARY

This section provides a general summary of the present disclosure and is not a comprehensive disclosure of its full scope or all of its features, aspects and objectives.

Accordingly, it is an aspect of the present disclosure to provide an ultrasonic object detection system for a motor vehicle including a vehicle body and a closure member attached to the vehicle body. The system includes at least one ultrasonic transducer attached to the vehicle body for selectively outputting a plurality of ultrasonic bursts and receiving a plurality of the ultrasonic echoes. The system also includes an electronic control unit that includes at least one ultrasonic driver electrically coupled to the at least one ultrasonic transducer and in communication with at least one vehicle controller. The electronic control unit is configured to receive a plurality of operational signals from the at least one vehicle controller. The electronic control unit is also configured to detect an activation gesture made by a user with the at least one ultrasonic transducer and transmit an activation signal to the at least one vehicle controller in response to detecting the activation gesture made by the user for operating the closure member.

It is another aspect of the present disclosure to provide a method of operating an ultrasonic object detection system for user-activation of a power closure member system to move a vehicle closure member of a vehicle. The method begins with the step of detecting a change in the state of the vehicle with one of a plurality of vehicle controllers of the vehicle to output a vehicle state change signal of the plurality of operational signals. The method continues by determining a baseline setting for at least one ultrasonic transducer based on a distance to a ground surface in response to receiving the vehicle state change signal. The method proceeds by detecting an activation gesture made by a user with the at least one ultrasonic transducer. The method also includes the step of transmitting an activation signal to the plurality of vehicle controllers to move the closure member in response to detecting the activation gesture.

It is yet another aspect of the present disclosure to provide an ultrasonic object detection system for a motor vehicle including a vehicle body and a closure member attached to the vehicle. The system includes a housing attachable to the vehicle and at least two ultrasonic transducers disposed within the housing for selectively outputting a plurality of ultrasonic bursts towards a ground surface about a perimeter of the vehicle and receiving a plurality of the ultrasonic echoes. The system also includes an electronic control unit disposed within the housing and including at least two ultrasonic drivers electrically coupled to the at least two ultrasonic transducers and in communication with at least one vehicle controller. The electronic control unit is configured to sequentially operate each of the at least two ultrasonic transducers as a transmitter of the plurality of ultrasonic bursts and a receiver of the plurality of ultrasonic echoes. The electronic control unit is also configured to detect an activation gesture made by a user with the at least two ultrasonic transducers and transmit an activation signal to the at least one vehicle controller in response to detecting the activation gesture made by the user for operating the closure member.

The ultrasonic object detection system according to the present disclosure provides numerous benefits, which are especially attractive to a user of the vehicle. The disclosed system increases foot detection area compared to existing solutions. This reduces the number of sensors or transducers to cover an area of detection. The disclosed system also allows the distance between the transducers and the reference surface to be reduced, while still allowing foot detection. This opens up applications on low clearance vehicles such as sedans, and sports cars. Additionally, the system can dynamically adapt to the surface distance from the transducer. This allows the system to provide versatility and adaptability to different environments and parking situations. Finally, the disclosed system also allows adapts to variable surfaces below the transducer to properly establish a baseline by avoiding false reference points.

These and other aspects and areas of applicability will become apparent from the description provided herein. The description and specific examples in this summary are intended for purpose of illustration only and are not intended to limit the scope of the present disclosure.

### DRAWINGS

Other advantages of the present disclosure will be readily appreciated, as the same becomes better understood by reference to the following detailed description when considered in connection with the accompanying drawings wherein:

FIG. 1 is a perspective view of an example motor vehicle equipped with a ultrasonic object detection system for a motor vehicle including a vehicle body and a closure member attached to the vehicle body which shows the location of at least one ultrasonic transducer according to aspects of the disclosure;

FIG. 2 is another perspective view of an example motor vehicle equipped with the ultrasonic object detection system according to aspects of the disclosure;

FIG. 3 is an enlarged view of a portion of the motor vehicle including an indicator according to aspects of the disclosure;

FIG. 4 is an enlarged view of a portion of an example rear bumper of the vehicle having the ultrasonic object detection system and which includes an indicator illuminated during activation (wake-up) and operation of the system according to aspects of the disclosure;

FIG. 5 illustrates the ultrasonic object detection system with a single ultrasonic transducer according to aspects of the disclosure;

FIG. 6A is an exploded view of an example ultrasonic object detection system including a single ultrasonic transducer which is mounted on the rear bumper according to aspects of the disclosure;

FIG. 6B is an exterior view of the example ultrasonic object detection system shown in FIG. 6A according to aspects of the disclosure;

FIG. 7A is an exterior side view of an example graphic of the ultrasonic object detection system including a pair of ultrasonic transducers constructed in accordance with the teachings of the present disclosure and which is mounted on a rear bumper, and wherein the bumper has clearance slots for ultrasonic waves conveyed to and/or from the ultrasonic transducers according to aspects of the disclosure;

FIG. 7B is a perspective view from inside the rear bumper of a sensor unit and the pair of ultrasonic transducers of the system of FIG. 7A according to aspects of the disclosure;

FIG. 7C is an exterior bottom view of the clearance slots of the rear bumper of FIG. 7A according to aspects of the disclosure;

FIG. 8A is an exterior side view of an example graphic of the ultrasonic object detection system including a single ultrasonic transducer mounted on the rear bumper, and wherein the bumper has a clearance slot for ultrasonic waves conveyed to and/or from the ultrasonic transducer according to aspects of the disclosure;

FIG. 8B is a perspective view from inside the rear bumper of an electronic control unit and the ultrasonic transducer of the system of FIG. 8A according to aspects of the disclosure;

FIG. 8C is an exterior bottom view of the clearance slot of the rear bumper of FIG. 7A according to aspects of the disclosure;

FIG. 9 illustrates the ultrasonic object detection system with a pair of ultrasonic transducers on an even ground surface according to aspects of the disclosure;

FIG. 10 illustrates the ultrasonic object detection system with a pair of ultrasonic transducers on an uneven ground surface according to aspects of the disclosure;

FIG. 11 illustrates an example optional trim bezel which can be installed around a graphic of the ultrasonic object detection system to cover manufacturing defects and/or misalignments according to aspects of the disclosure;

FIG. 12 is an overall functional diagram of the electronic control unit according to aspects of the disclosure;

FIG. 13 illustrates the ultrasonic object detection system with a plurality of ultrasonic transducers according to aspects of the disclosure;

FIGS. 14, 14A and 14B illustrate the ultrasonic object detection system with the plurality of ultrasonic transducers operating sequentially according to aspects of the disclosure;

FIGS. 15-17 illustrate example situations when a distance between the ground surface and the ultrasonic transducers can change according to aspects of the disclosure;

FIG. 18 illustrates a flow of data for the electronic control unit receiving at least one inhibit signal according to aspects of the disclosure;

FIGS. 19-21 illustrate a method of operating an ultrasonic object detection system for user-activation of a power closure member system to move a vehicle closure member according to aspects of the disclosure; and

FIG. 22 illustrates overall operation timing sequence of the ultrasonic object detection system.

### DETAILED DESCRIPTION OF EXAMPLE EMBODIMENTS

In general, at least one example embodiment of an ultrasonic object detection system constructed in accordance with the teachings of the present disclosure will now be disclosed. A method of operating the ultrasonic object detection system constructed in accordance with the teachings of the present disclosure will also be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail. Also, the system could alternatively be used to open and/or close another closure member of a vehicle.

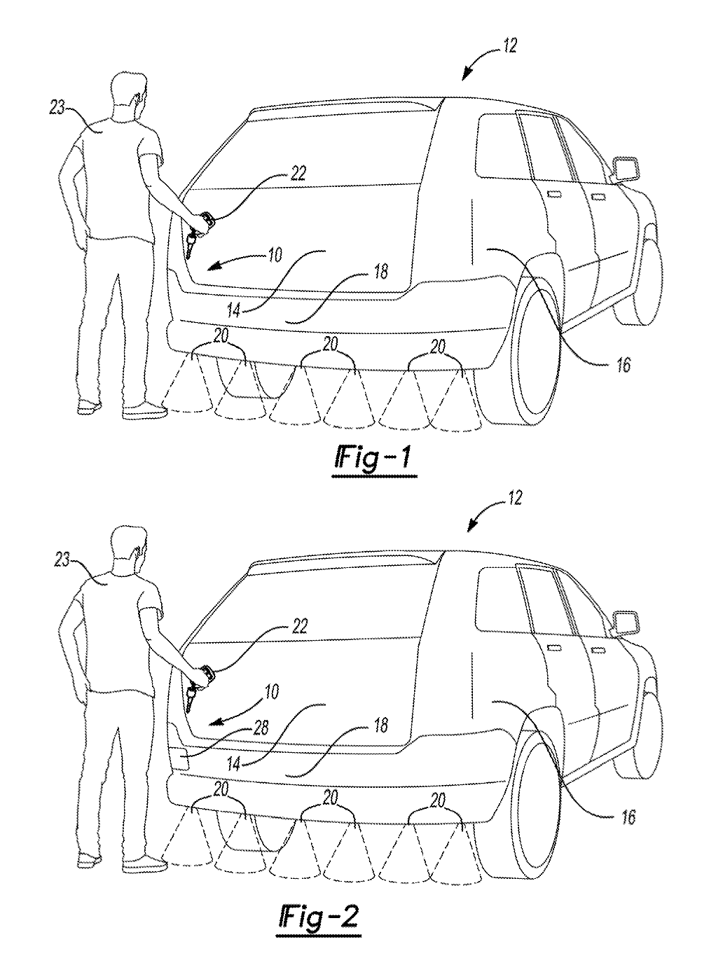

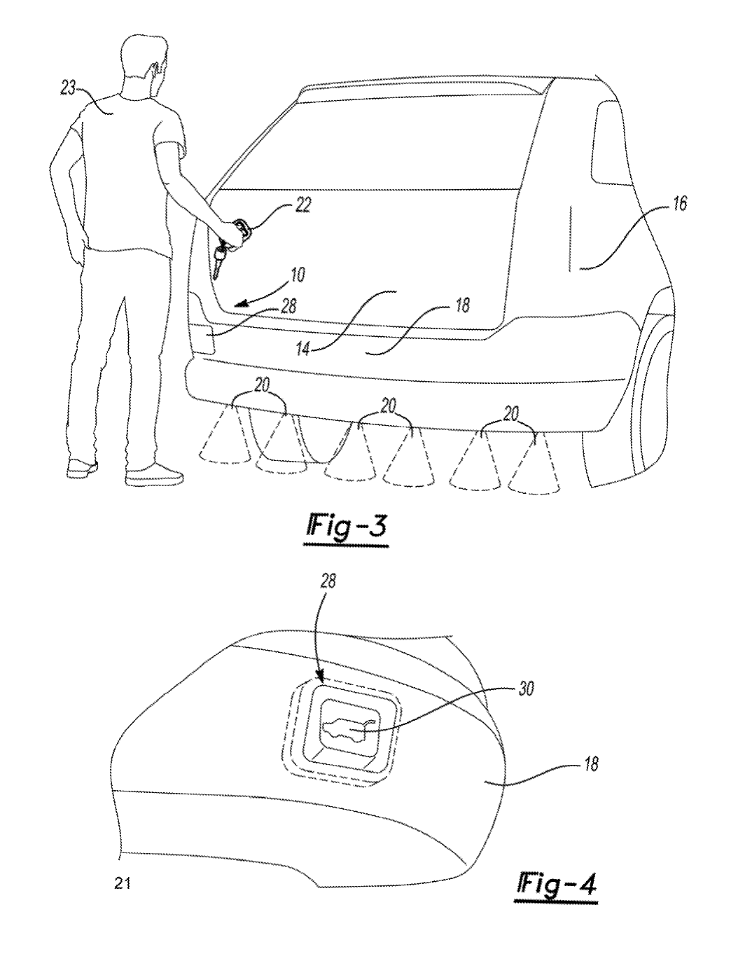

Referring initially to FIGS. 1-4, the ultrasonic object detection system 10 is shown on an example motor vehicle 12 that includes a closure member (e.g., rear liftgate 14) mounted to a vehicle body 16. According to the example embodiment described in the present disclosure, the ultrasonic object detection system 10 is integrated into a rear bumper 18 of the vehicle body 16. However, the ultrasonic object detection system 10 could be placed at another location on the vehicle 12, for example on the side of the vehicle 12 adjacent the side vehicle passenger doors as shown in FIGS. 1 and 2. It should be appreciated that the ultrasonic object detection system 10 can be used in connection with other applications including non-contact (i.e., gesture based) activation of power opening of other closure members such as power doors, power trunks and power sliding doors. In addition, these techniques could also apply to other non-automotive applications that could benefit from gesture based activation of systems.

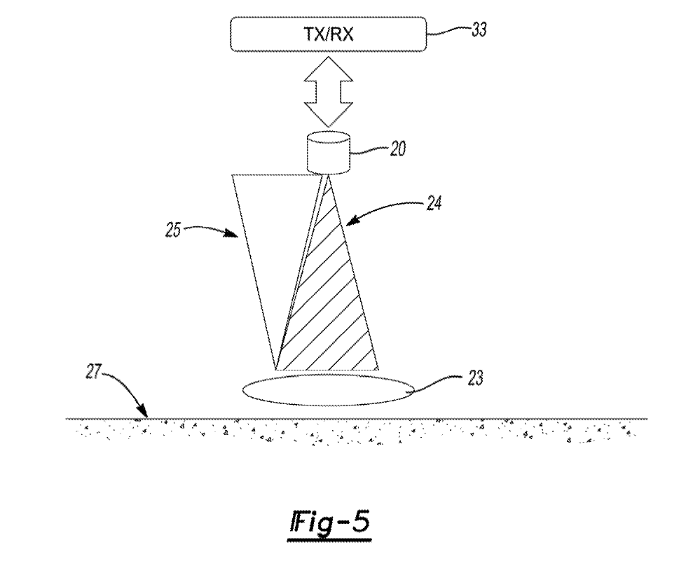

The ultrasonic object detection system 10 includes at least one ultrasonic transducer 20 which senses an object or motion when a key fob 22 associated with the specific vehicle 12 is located within a predetermined distance of the vehicle 12, for example when the key fob 22 is in possession of a user 23 approaching the vehicle 12. In more detail, the at least one ultrasonic transducer 20 is attached to the vehicle body 16 for selectively outputting a plurality of ultrasonic bursts 24 and receiving a plurality of the ultrasonic echoes 25, as best shown in FIG. 5. Although the key fob 22 is used in the example embodiment, another component associated with the specific vehicle 12 and which can be detected by the vehicle 12 could be used. An example of the object detected by the ultrasonic transducer(s) 20 is a foot of the user 23, and an example of the motion detected by the ultrasonic transducer(s) 20 is a kicking or waving motion of the user 23.

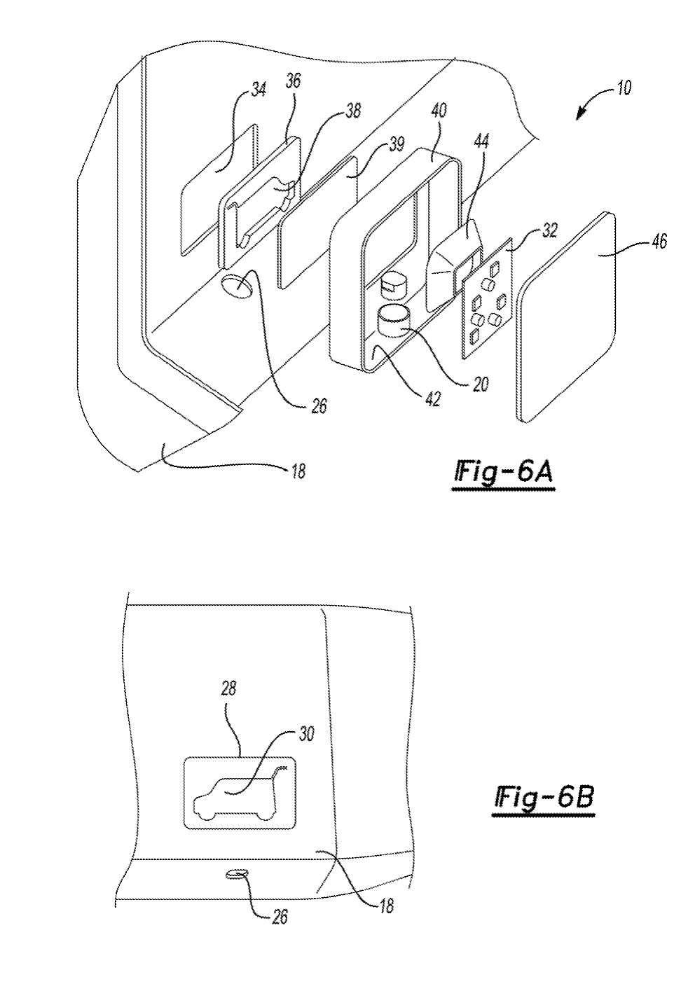

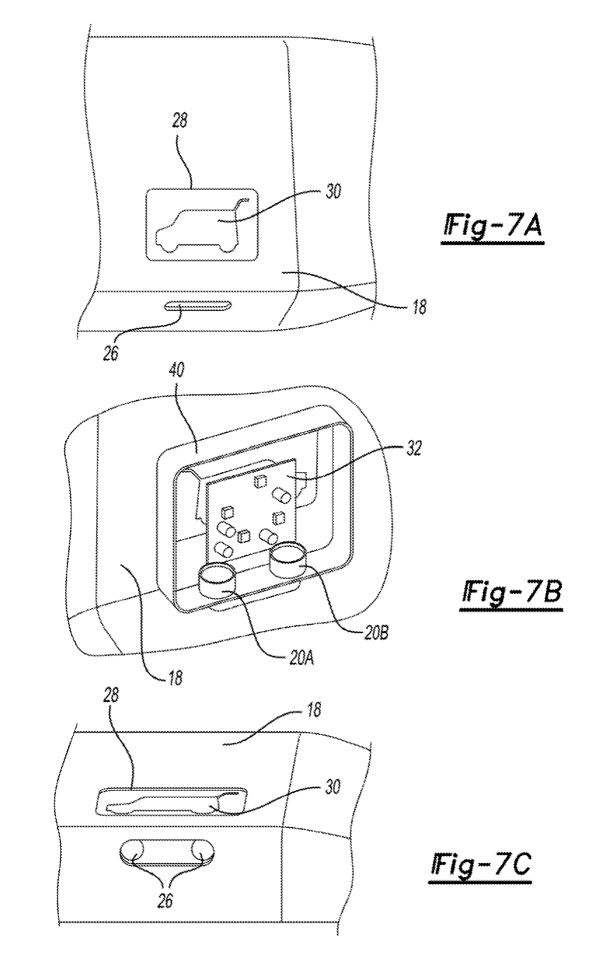

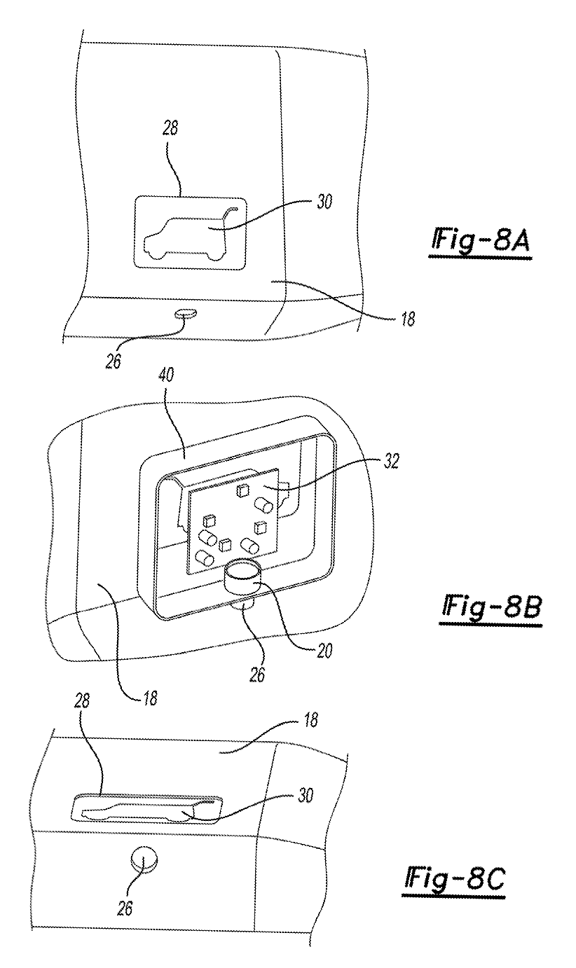

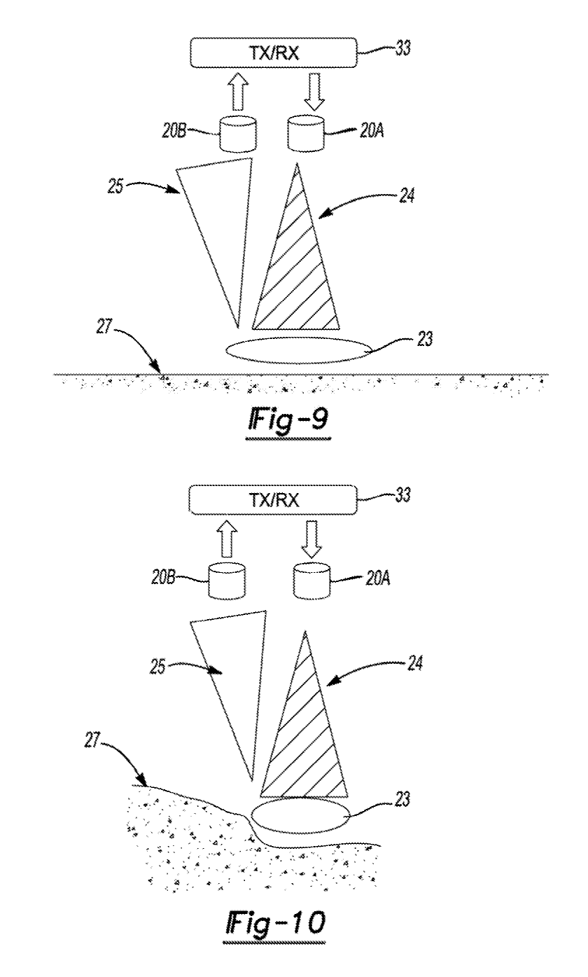

Because the ultrasonic transducers emit ultrasonic waves or bursts 24, the rear bumper 18 can include a clearance slot 26, illustratively provided on an underside 21 of the rear bumper 18 as best shown in FIGS. 4, 6A-6B, 7A-7C, and 8A-8C, to allow ultrasonic waves (ultrasonic bursts 24 and ultrasonic echoes 25) to be conveyed to and/or from each ultrasonic transducer 20, for example between the rear liftgate 14 and the ground 27 (FIGS. 9, 10, 13, and 14). According to one embodiment, the ultrasonic object detection system 10 includes a single ultrasonic transducer 20, as shown in FIGS. 6A-6B and 8A-8C. According to one embodiment, the ultrasonic object detection system 10 includes a pair of ultrasonic transducers 20A, 20B, referred to as dual sensors, as shown in FIGS. 7A-7C. In this embodiment, one of the ultrasonic transducers 20A, 20B transmits and the other receives or listens, as best shown in FIGS. 9 and 10. The ultrasonic transducers 20A, 20B provide the system 10 with an advantage over comparative systems which only include a single ultrasonic transducer 20. If there is only a single ultrasonic transducer 20, due to close range, feedback and ringing (e.g. a non-stable sensor membrane) which interferes with operation and detection can occur. The dedicated transmit (Tx) and receive (Rx) ultrasonic transducers 20A, 20B eliminate this feedback and ringing problem. The ultrasonic transducers 20, 20A, 20B are oriented towards the ground 27, for example to direct pulses/chirp in a vertical direction or substantially vertical direction emanating in illustratively a cone pattern. The term substantially vertical direction is used herein to refer to a direction that is not horizontal such that a detection zone is located either directly beneath or substantially beneath extending from an area directly beneath is provided e.g. a detection cone projecting from the ultrasonic transducers 20, 20A, 20B at a 45 degree angle from the vertical. Such an orientation ensures the ultrasonic transducers 20, 20A, 20B are able to capture gestures (e.g. gestures of a user's foot) in a predefined location to avoid false activations from motions or gestures (e.g. hand or arm or leg gestures) outside the detection zone which do not correspond to gestures made by a user with the intent to activate the ultrasonic transducers 20, 20A, 20B. For example, the detection zone may be configured for detection directly beneath or substantially beneath the outer perimeter of the vehicle 12, shown as a projected perimeter 19 matching with the actual outer perimeter of the vehicle 12, or extending somewhat beyond the perimeter 19 (e.g., 20 cm). It is recognized that a further outwardly projected perimeter (e.g., greater than 20 cm) or inwardly projecting perimeter may be provided.

As shown in FIGS. 2-4, 6A-6B, 7A-7C, 8A-8C, and 11 the ultrasonic object detection system 10 also includes an indicator 28 located on the vehicle 12 to inform the user 23 of the appropriate location to make an activation gesture which initiates opening of the closure member (e.g., rear liftgate 14). Illustratively the indicator 28 is oriented or substantially oriented in the horizontal direction relative to the ground 27. The activation gesture could be a movement made by the user 23, and/or or an object placed by the user 23 adjacent the ultrasonic transducer(s) 20. In the example embodiments, the indicator 28 is located adjacent the ultrasonic transducer(s) 20, for example on the rear bumper 18 of the vehicle 12. The indicator 28 can also inform the user 23 if the system 10 is activated or powered up, during system wake-up, in motion, has detected the user 23 approaching the vehicle 12, that the system 10 is receiving input from the user 23, and/or if the system 10 is waiting for the activation gesture signal. The indicator 28 of the example embodiment includes a graphic 30, also referred to as an icon, for example a lighted picture of an opened rear liftgate, to alert the user 23. The use of an actual icon located properly provides the user 23 with a visual indicator of where the ultrasonic transducer(s) 20 is located. This feature is beneficial to the user 23 and provides an advantage over comparative systems, which require the user 23 to guess where a sensor or transducer 20 is located below a rear bumper 18 (or other part of the vehicle equipped with the system 10) and where the detection zone of the ultrasonic transducers 20, 20A, 20B is directed for making the activation gesture. While exemplarily embodiments are made herein with reference to the employment of the indicator 28, the ultrasonic object detection system 10 may be provided without the indicator 28 (e.g., the ultrasonic transducer(s) 20 could, for example, be positioned on or behind the rear bumper 18 without any indicator 28 or with an indicator 28 without the graphic 30).

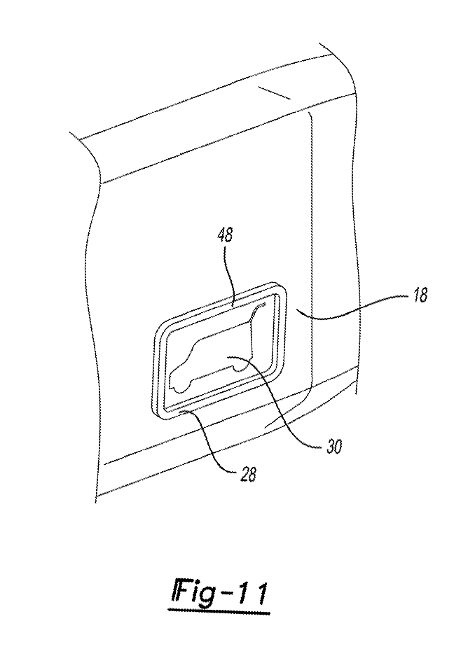

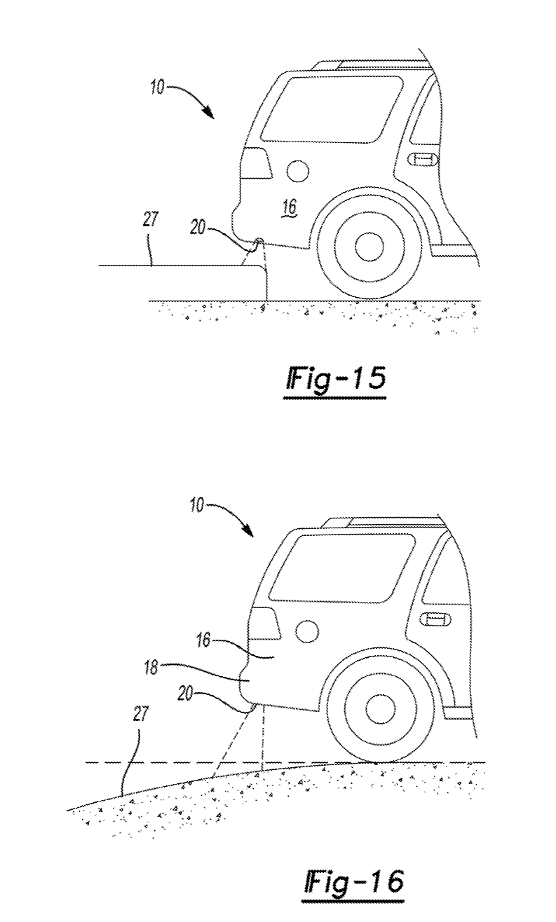

An exploded view of the ultrasonic object detection system 10 with one ultrasonic transducer 20, according to the example embodiment is shown in FIG. 6A. The rear bumper 18 defines an opening 34 for various components and the clearance slot 26 for ultrasonic waves transmitted to and/or from the ultrasonic transducer 20. An image cover 36 is disposed over the opening 34 which includes a cutout 38 of the graphic 30, in this case the vehicle 12 with the opened rear liftgate 14. The image cover 36 is also painted to match the color of the vehicle body 16. An image diffuser 39, for example a translucent white plastic, is disposed over the image cover 36. Next, a housing 40 is disposed over the image diffuser 39. The ultrasonic transducer 20 is contained in the housing 40 and rests on a base wall 42 of the housing 40. A reflector 44 which directs light to the image or area of the graphic 30 is also disposed in the housing 40 adjacent the transducer 20. The electronic control unit 32 is also disposed in the housing 40. In the example embodiment, light emitting diodes (LEDs) are located on the far side of the electronic control unit 32. A cover 46 is disposed over the housing 40. As shown in FIG. 6B, which is an exterior view of the system 10 of FIG. 6A, the graphic 30 is visible through the image cover 36. As shown in FIG. 11, the system 10 optionally includes a bezel 48 installed from the exterior of the rear bumper 18 to cover any manufacturing defects and/or misalignments that may be present. While the at least one ultrasonic transducer 20 may be inside the housing 40, it should be appreciated that the at least one ultrasonic transducer 20 may also be separately disposed on the vehicle 12 (FIGS. 15-17).

The ultrasonic field provided by the at least one ultrasonic transducer 20 can be a three-dimensional volume, e.g. hemispherical shape, cube, cone, or cylinder. The at least one ultrasonic transducer 20 is used to receive reflections from interactions in the ultrasonic field and the system 10 processes and analyzes the received reflections to provide gesture data usable to determine gestures for opening the rear liftgate 14. According to the example embodiment, as the user 23 approaches the vehicle 12, the vehicle 12 senses the key fob 22 and activates the ultrasonic object detection system 10 and the indicator 28. The ultrasonic object detection system 10 has a triggering event mode and a non-triggering event mode. The indicator 28 in accordance with the example embodiment is a light disposed on the rear bumper 18 to notify the user 23 that the system 10 is activated and waiting for the activation gesture from the user 23 to open the rear liftgate 14. The indicator 28 also notifies the user 23 of the correct position to perform the activation gesture, e.g., the presence of a foot. At the same time, the at least one ultrasonic transducer 20 produces the ultrasonic field adjacent to the indicator 28 and the vehicle 12 e.g., an ultrasonic field directed beneath or substantially beneath the vehicle 12.

For the example embodiment, the indicator 28 notifies the user 23 by illuminating a red light. To initiate the triggering event mode, the user 23 places his or her foot under the lighted indicator 28, or underneath the rear bumper 18 as an illustrative example. When the user 23 places his or her foot under the lighted indicator 28, the at least one ultrasonic transducer 20 of the system 10 receives reflections from interactions in the intermediate ultrasonic field. Then, the system 10 processes and analyzes the received reflections to provide gesture data usable to determine the gesture. For the system 10 to process the received reflections, the user 23 may have to leave his or her foot stationary for a require period of time (e.g., four seconds). Once the user 23 leaves his or her foot stationary for the required period of time and the proper gesture is provided, the indicator 28 notifies the user by flashing an illuminated yellow light. Next, the system 10 initiates the opening of the rear liftgate 14. On the other hand, if the user 23 leaves his or her foot stationary but does not meet the required period of time (e.g., less than four seconds) needed to initiate the opening of the rear liftgate 14, the non-triggering event mode is initiated. During the non-triggering event, the indicator 28 quickly flashes the illuminated yellow light to indicate to the user 23 that the gesture made by the user 23 does not meet the requirement for opening the rear liftgate 14.

It should be appreciated that various techniques may be used for the detecting the interactions in the ultrasonic field. For the example embodiment, the gesture technique is based on motion detection and to unlock or actuate the system 10 (door or liftgate 14) the user 23 has put his or her foot in the range of the at least one ultrasonic transducer 20, and then wait a period of time before moving his or her foot out of the range of the at least one ultrasonic transducer 20 to activate the system 10. In other words, the user 23 must put his or her foot in the ultrasonic field for the required period of time before removing his or her foot. No movements are allowed within the period after the first detection. So, for example, the foot must be stationary for 500 ms. If the system 10 detects a second movement within the period, the algorithm will ignore the first detection and go to a reset state and then wait for a new input. During the required period of time, to activate the system 10, it is preferred that the user 23 makes no additional movements in the ultrasonic field. If the system 10 detects a second interaction, i.e. an additional movement made by the user 23, in the ultrasonic field within the required period of time, the first interaction detected by the at least one ultrasonic transducer 20 will be ignored by the system 10 and the system 10 will reset and wait for a new interaction made by the user 23. Nevertheless, it should be understood that other algorithms and/or periods of time can be utilized. For example, a back and forth movement, or single movement, or tap(s) of a foot in the ultrasonic field may be required to activate the system 10.

An audible warning tone, honk, or beep can also be used, with or without the graphic 30, to alert the user 23. The indicator 28 can also include other features or components to notify the user 23, for example another type of light or lighted area along or near the rear bumper 18, tail lights, reverse lights, signal lights, an object or projection on a glass of the vehicle 12, for example a projected image or light. According to one example embodiment, the indicator 28 has a different color in the ON and OFF state and provides the user 23 with an idea of where to place his or her foot. Additionally, the indicator 28 used to notify the user 23 may be any other area on the vehicle 12 that could be visible to the user 23. In summary, various options are possible for the feature or features used as an indicator 28 to notify the user 23. In each instance, feedback is provided to the user 23 for foot/gesture detection.

According to the example embodiment, as the user 23 approaches the vehicle 12, the vehicle 12 senses the key fob 22 and powers on the ultrasonic object detection system 10. Once the system 10 wakes up, the ultrasonic transducers 20A, 20B and indicator 28 are activated. In the example embodiment, the indicator 28 is a lighted picture on the rear bumper 18 to notify the user 23 that the system 10 is activated and waiting for the activation gesture from the user 23 to open the rear liftgate 14. The indicator 28 also notifies the user 23 of the correct position to perform the activation gesture, which in this case is the presence of a foot. The user 23 then places his or her foot under the lighted indicator 28, which may include directly or substantially directly below the vehicle bumper 18. Once the foot is detected, the indicator 28 flashes and optionally an audible tone can be made by the system 10 or another component of the vehicle 12 to indicate the presence of the foot. The user 23 then leaves his or her foot stationary for a required period of time needed to initiate opening of the rear liftgate 14. On the other hand, if the user 23 leaves his or her foot stationary but does not meet the required period of time, i.e., less than the period of time needed to initiate the opening of the rear liftgate 14, the indicator 28 flashes and optionally an audible tone can be made by the system 10 or another component of the vehicle 12 to indicate that the gesture made by the user does not meet the requirement for opening the rear liftgate 14.

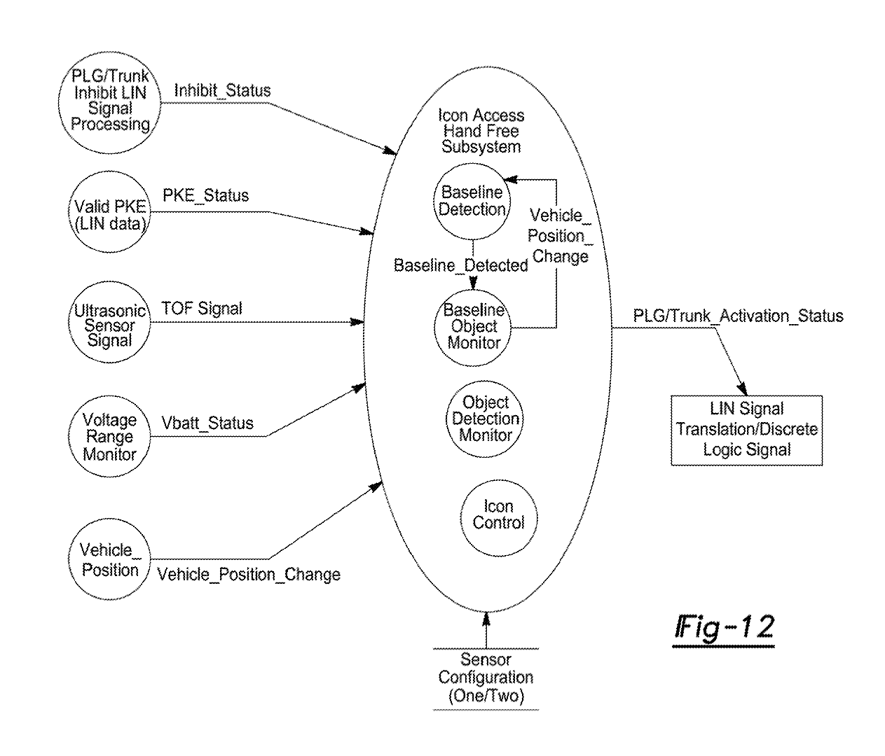

The system 10 also includes an electronic control unit 32 executing software, which initiates the opening of the rear liftgate 14. A functional diagram of the electronic control unit 32 is shown in FIG. 12. The electronic control unit 32 is electrically coupled to the indicator 28 and includes at least one ultrasonic driver 33 electrically coupled to the at least one ultrasonic transducer 20 and in communication with a plurality of vehicle controllers, such as a Body Control Module, for example through a Local Interconnect Network (LIN) interface. The electronic control unit 32 is configured to receive a plurality of operational signals from the plurality of vehicle controllers. For example such plurality of operational signals include but are not limited to signal indicating a change in vehicle state from a drive state to a parked state (e.g. the user has moved his transmission from a Drive to a Park mode), a change in vehicle state from a moving state to a stopped state (e.g., the user has moved and has dropped his vehicle speed to below 0 miles per hour), or a change in vehicle state from a moving state above a threshold speed to below a vehicle threshold speed (e.g., the user has moved has dropped his vehicle speed to below 1 mile per hour); an expiry of a sleep timer, or a change in vehicle state of the vehicle closure panels between locked and unlocked. The electronic control unit 32 is also configured to detect the activation gesture made by the user 23 with the at least one ultrasonic transducer 20 (e.g., with one ultrasonic transducer 20, shown in FIG. 5 and with a pair of ultrasonic transducers 20A, 20B in FIG. 9) and transmit an activation signal to the plurality of vehicle controllers in response to detecting the activation gesture made by the user 23 for operating the closure member (e.g., rear liftgate 14).

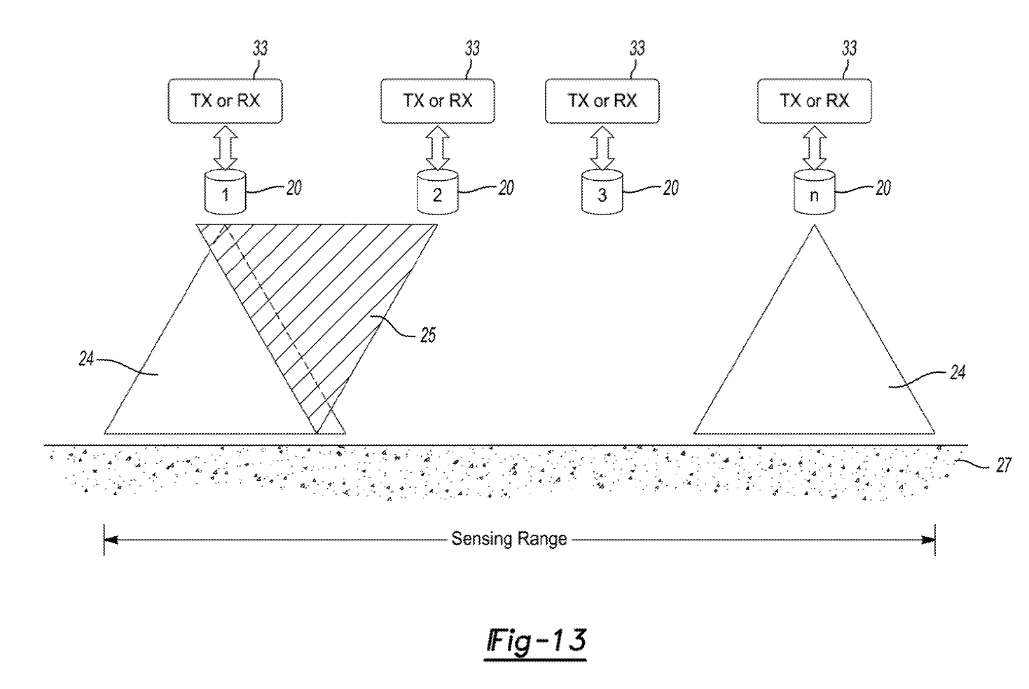

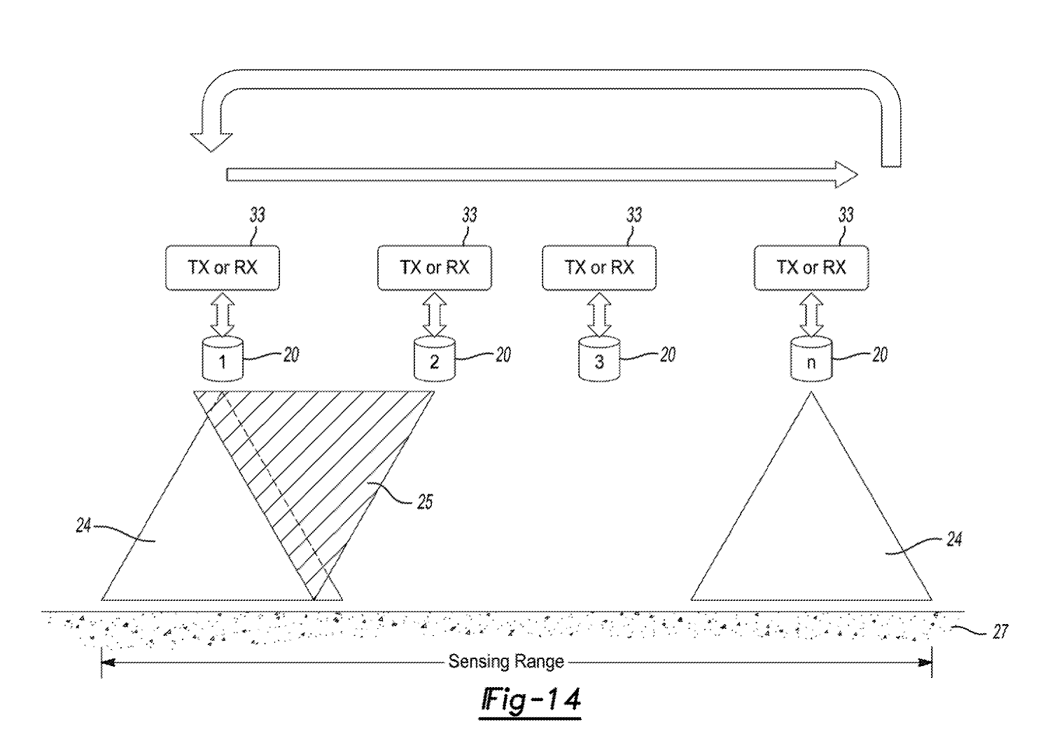

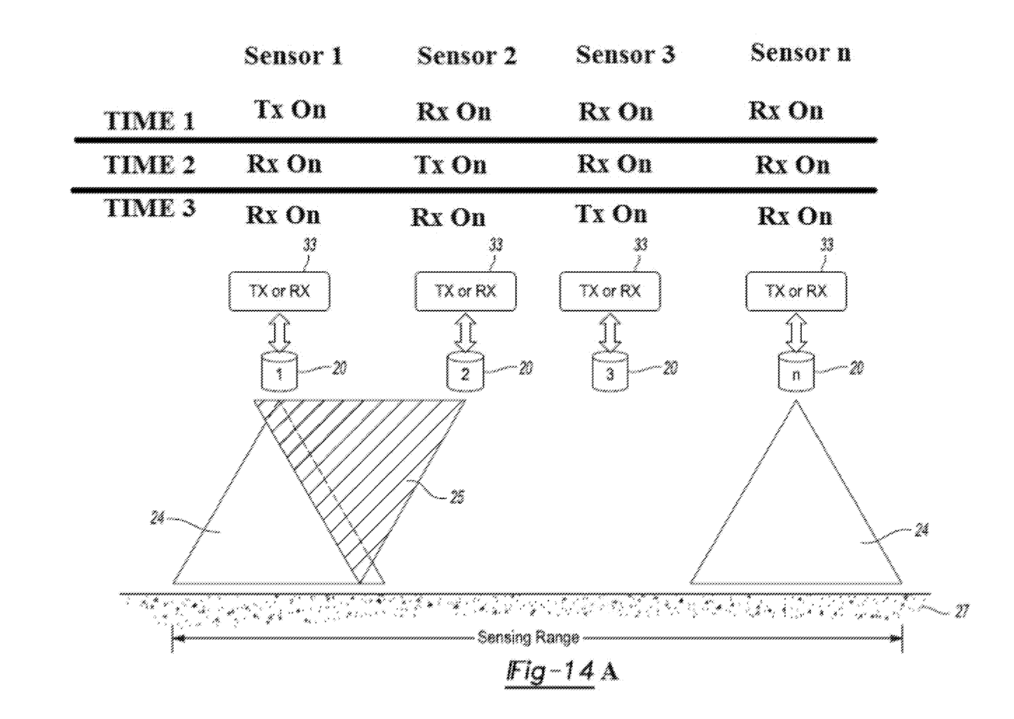

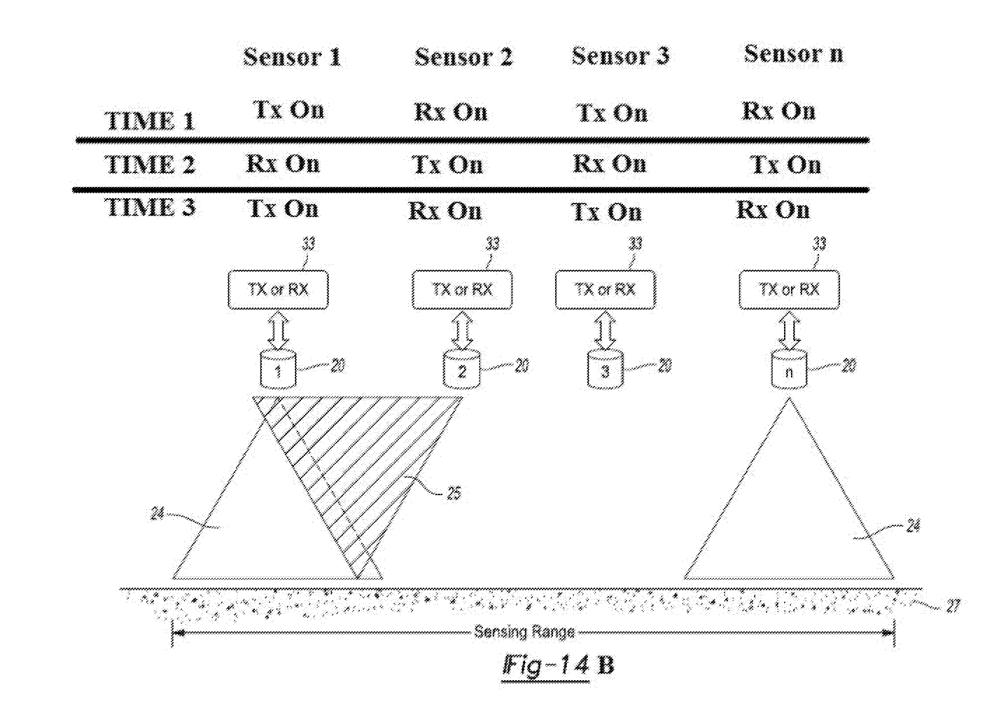

In the event that the at least one ultrasonic transducer 20 includes a plurality of ultrasonic transducers 20 (FIG. 13), the electronic control unit 32 is further configured to sequentially operate each of the plurality of ultrasonic transducers 20 as a transmitter of the plurality of ultrasonic bursts 24 and a receiver of the plurality of ultrasonic echoes 25, as best shown in FIG. 14. For example, the electronic control unit 32 can be configured to operate each of the plurality of ultrasonic transducers 20 as one of the transmitter of the plurality of ultrasonic bursts 24 and the receiver of plurality of the ultrasonic echoes 25 opposite the operation of an adjacent one of the plurality of ultrasonic transducers 20 as one of the transmitter of the plurality of ultrasonic bursts 24 and the receiver of plurality of the ultrasonic echoes 25. The plurality of ultrasonic transducers 20 or sensor units can be arranged along a periphery of the rear bumper 18 in an array. The array is configured so as to eliminate the effect of ringing on detection ability. One of the ultrasonic transducers 20 is configured to a transmit mode to emit a pulse/chirp 24, while adjacent ultrasonic transducers 20 are set to a receive mode to receive the reflected waves 25. Since a different ultrasonic transducers 20 receives the reflected waves 25, the system 10 does not have to wait for the ultrasonic transducer 20 to settle to a stable state (as would be the case of an ultrasonic transducer 20 configured to both transmit the ultrasonic burst 24 and receive the reflected signal or echo 25).

In operation for example, the system 10 is configured (i.e. an algorithm executed by a microcontroller of the electronic control unit 32) to have one sensor or ultrasonic transducer 20 transmit the bursts 24 and others configured as receivers of the echoes 25. With this configuration, the adjacent receiving ultrasonic transducer 20 (i.e., sensor or transducer “2” shown in FIG. 13) are already in a steady state and ready to receive reflected signals (e.g., echoes 25) without interference due to a pre-existing vibration of the receiver membrane. Note, not all ultrasonic transducers 20 will be able to receive the echoes 25 (i.e., sensors or transducers “3” and “4” of FIG. 13 may not receive the reflected signal or echo 25). For example, sensor or transducer “1” transmits the bursts 24, transducer “2” will able to receive the echoes 25, transducer “3” may receive the echoes 25, but transducer “4” and beyond may not receive the echoes 25, since they are out of a range of the echoes 25. The next sequence, transducer “2” will be a transmitter and others will be receivers and so on and so forth. The ultrasonic transducers 20 are operated in a sweeping manner, or sequenced manner to cover the area below the rear bumper 18. For example, transducer “1” transmits the bursts 24, transducer “2” may not have reached a stable state (e.g. not ringing) sufficient for accurate minimal interference detection received echoes 25, transducer “3” may receive the echoes 25, whereas transducer “3” and beyond may be able to receive the echoes 25, since they are within range of the echoes 25 and have reached a stable non-ringing state. The next sequence, transducer “2” will be a transmitter and others will be receivers (e.g. transducer “4”) and so on and so forth. The ultrasonic transducers 20 are operated in a sweeping manner, or sequenced manner to cover the area below the rear bumper 18. Alternative manners of scanning the ground 27 may be provided for, for example transducer “1” and transducer “3” may be configured to receive the echoes 25 while transducer “2” and transducer “4” transmit the bursts 24, followed next by an inversion of operation to operate the transducer “1” and transducer “3” to transmit the bursts 24, where transducer “2” and transducer “4” previously operating to transmit the bursts 24 are allowed to reach a stable non-ringing state before being configured to receive the echoes 25.

By using more ultrasonic transducers 20 provided in an array in a displaced manner relative to one another with one transmitting, while adjacent ultrasonic transducers 20 are set to receive, the detection area can be increased. Thus, the distance between the ultrasonic transducers 20 and the ground 27 can be reduced, thereby requiring less ultrasonic transducers 20 for monitoring a sensing range and also the width of the beam can be increased, since reflections do not need to propagate back to the transmitting sensor, but can be rather picked up or detected by adjacent ultrasonic transducers 20. As a result, the system 10 can be applied to vehicles 12 having lower ground clearance, such as for sport cars, as compared to trucks and SUVs. Additionally, since the ultrasonic transducers 20 are effective for detecting a gesture closer to the ultrasonic transducers 20 compared to known systems having inoperative areas of detection directly in front of the transducers, ultrasonic transducers 20 can be placed at lower positions about the perimeter of the vehicle 12, and in particular beneath the vehicle 12 where is can provide the advantage of being hidden from view from the user 23 compared to known systems, which are visible, as they required higher positions for operation, such as at mid-point on a bumper. By allowing the transmitting and receiving ultrasonic transducers 20 to reach a steady state before transmitting or receiving again, sensitivity of the system 10 can be increased, since the vibrations of the ultrasonic transducers 20 are only produced by the received reflected signals, or echoes 25, and not residual vibrations resulting from a transmit pulse/chirp 24. To do so the ultrasonic transducers 20 are arranged to sweep the detection zone, that is they will be configured to transmit in sequential order to allow a transmitter ultrasonic transducer 20 time to settle before it must receive again.

When an object or motion is detected by the ultrasonic transducer(s) 20, such as the foot of the user 23, the ultrasonic transducer(s) 20 send signals related to the object or motion to the electronic control unit 32. The electronic control unit 32 processes the data from the ultrasonic transducer(s) 20 to determine if the object or motion is the activation gesture required to open the rear liftgate 14, rather than a false signal. If the data indicates the presence of the correct activation gesture, the electronic control unit 32 issues instructions to the applicable vehicle controller(s) to initiate opening of the rear liftgate 14. In the example embodiment, when the rear liftgate 14 is about to open or is opening, the indicator 28, for example the lighted graphic 30 and audible tone, are activated to notify the user 23.

A possible drawback of the use of ultrasonic transducers 20 is that ultrasonic transducers 20 are typically baselined (reference distance) to a predetermined distance based on the vehicle 12 being stationary on a flat surface, meaning that ultrasonic transducers 20 are calibrated (i.e., detection algorithms based on certain reflection times parameter, for example using a time-of-flight algorithm) assuming that the ultrasonic transducers 20 remains at a height relative to the ground 27 that is constant, represented as reference A in FIG. 16 as an example. That is, the baseline reference point for the system is assumed to never change, despite the possibility of the distance between the ultrasonic transducers 20 positioned on the bumper 18 and the ground 27 changing depending on the road conditions. As best shown in FIG. 15, the vehicle 12 may be backed up and the bumper 18 may be located about a raised curb which would decrease the distance between the ultrasonic transducers 20 and the baseline reference surface from which the ultrasonic field would reflect off of, and upon which any object or motion would be detected from. As shown in FIG. 16, the vehicle 12 may be parked on a ramp which would lower or raise the height of the bumper 18 relative to the ramp surface, and increase the distance of the baseline reference surface away from the ultrasonic transducers 20 and upon which any object or motion would be detected from. Also, as shown in FIG. 17, the vehicle 12 may be in an off-roading situation, where it is parked next to a pile of rocks, ice, snow, or dirt or other uneven or unlevel terrain and different ultrasonic transducers 20 may have different reference points for each ultrasonic transducers 20 operating to detect a motion or object below the ultrasonic transducers 20 forming an array of ultrasonic transducers 20 provided across a portion of the perimeter of the vehicle 12, such as below the extents of a bumper 18. In all these cases, the baseline reference of the ground is not adjusted and the ultrasonic transducers 20 calculations for detecting an object are not able to detect an object properly, due to ringing in the scenario where the baseline reference surface is closer to the ultrasonic transducers 20 (e.g. curb) or incorrect reflection times and detection algorithm calculations (e.g. time of flight calculations) in the scenario where the baseline reference surface is farther away from the ultrasonic transducers 20 than the calibrated height of known systems.

According to the example embodiment, the electronic control unit 32 first establishes a baseline measurement or setting, which can be a distance between the ultrasonic transducer(s) 20 and a ground surface beneath the vehicle 12 (e.g., below the rear liftgate 14) without any obstacles. For example, the ultrasonic data from the ultrasonic transducer(s) 20 can be sampled every 20 ms (e.g., for five samples, for total of 100 ms), and all samples must be within 10 mm tolerance to be considered to be a valid baseline data. The baseline setting can be re-established every power on reset, wakeup and when vehicle 12 is moved to different location. The electronic control unit 32 then continues to monitor the sensor data or signals and looks for a change in the baseline measurement that exceeds a given threshold distance. Once the threshold distance has been exceeded, the electronic control unit 32 perceives this as the correct activation gesture, rather than a false signal, and communicates to at least one of the plurality of vehicle controllers that an opening or closing request has been given. If the detected data does not meet the threshold set, then the electronic control unit 32 determines a false signal occurred, for example which could occur by an object unintentionally moving beneath the rear bumper 18. After the correct activation signal is communicated from the electronic control unit 32, the vehicle controller (e.g., a power closure member actuation system) can then initiate the opening of the closure member (e.g., rear liftgate 14). According to the example embodiment, the system 10 again optionally flashes the indicator 28 and makes the audible tone to indicate opening of the rear liftgate 14, and the rear liftgate 14 opens.

Referring back to FIG. 9, in the illustrated configuration with a pair of ultrasonic transducers 20A, 20B arranged with one for transmitting and another for receiving within the same unit. Reflections are received from an adjacent ultrasonic transducer (e.g., ultrasonic transducer 20B), which is in a steady state. Ringing therefore does not occur and allows the ultrasonic transducers 20A, 20B to be brought closer to the ground 27. In another embodiment, more than two ultrasonic transducers 20A, 20B provided in the same unit may be provided further allowing the ultrasonic transducers 20A, 20B operating as receivers to achieve a stable state (e.g. not ringing), to allow the unit to be further positioned closer to the ground 27. Also, by providing for the adjacent ultrasonic transducer (e.g., ultrasonic transducer 20B) to be operated in alternating on/off states (i.e., first pulse by transducer 20A, transducer 20B set to receive mode, then second pulse by transducer 20B, transducer 20A set to receive mode), the characteristics of the ground 27 can be ascertained to properly establish a correct baseline before the ultrasonic transducers 20A, 20B operate in a detection mode. As shown FIG. 9, the reference ground is even. If the ultrasonic transducers 20A, 20B both register the same reflection time (i.e., the time a burst signal 24 is transmitted and an echo signal 25 received), the system 10 can conclude that the ground 27 is flat or even. However, as best shown in FIG. 10, where the reference ground 27 is uneven, the ultrasonic transducers 20A, 20B register different reflection times when establishing the baseline setting and the system 10 can conclude that the ground 27 is uneven (e.g., this would be, for example, when the vehicle 12 is parked next to a curb). Prior art systems would likely register the distance to be based on the lesser reflection time, placing the baseline reference point as the curb nearer to the sensor or ultrasonic transducer 20A, 20B. As a result, if an object or foot is placed below the curb, on the actual pavement, the prior art system will not be calibrated to recognize the object, and the system will not know to activate the liftgate 14. By providing adjacent ultrasonic transducers 20A, 20B operating in alternating transmit and receive modes, the system 10 is able to detect this difference in baselines when reflections 25 are received at different times, indicating an uneven surface 27. The system 10 can then set the baseline accordingly, i.e. according to the farther surface to be able to register a foot movement about that reference line. Alternatively, the system 10 can be configured to detect objects/movement with a baseline reference set to both detected different baselines e.g. the system 10 can be configured set the adjacent ultrasonic transducers 20A, 20B operating in transmit and receive modes to detect objects/movement with baseline set to the curb (a closer baseline) to determine if a foot has been placed on the curb, and subsequently the system 10 can be configured to set the adjacent ultrasonic transducers 20A, 20B to operate in alternate transmit and receive modes to determine if a foot has been placed on the pavement below the curb with the baseline set to the pavement (a farther baseline).

The plurality of operational signals received by the electronic control unit 32 can, for example, include a vehicle state change signal, such as a location change signal, a transmission change state signal, a speed change state signal, a parking brake state change signal, and the electronic control unit 32 can then be configured to determine a baseline setting for the at least one ultrasonic transducers 20 based on a distance to a ground surface 27 in response to receiving the vehicle state change signal. A vehicle state change signal can for example, be based on, or comprise vehicle odometer values or other signal on the LIN bus if it is available. Other signals can include, but are not limited to PRNDL or gear selection, vehicle ignition state, and vehicle speed information. If, for example, the at least one ultrasonic transducer 20 includes a plurality of ultrasonic transducers 20, the determination for the baseline setting can be completed for each of the plurality of ultrasonic transducers 20 as a function of the terrain 27 below the vehicle 12. Therefore the system 10 can provide for dynamic baseline setting to improve positive activation commands over rough, uneven, and/or different terrains 27.

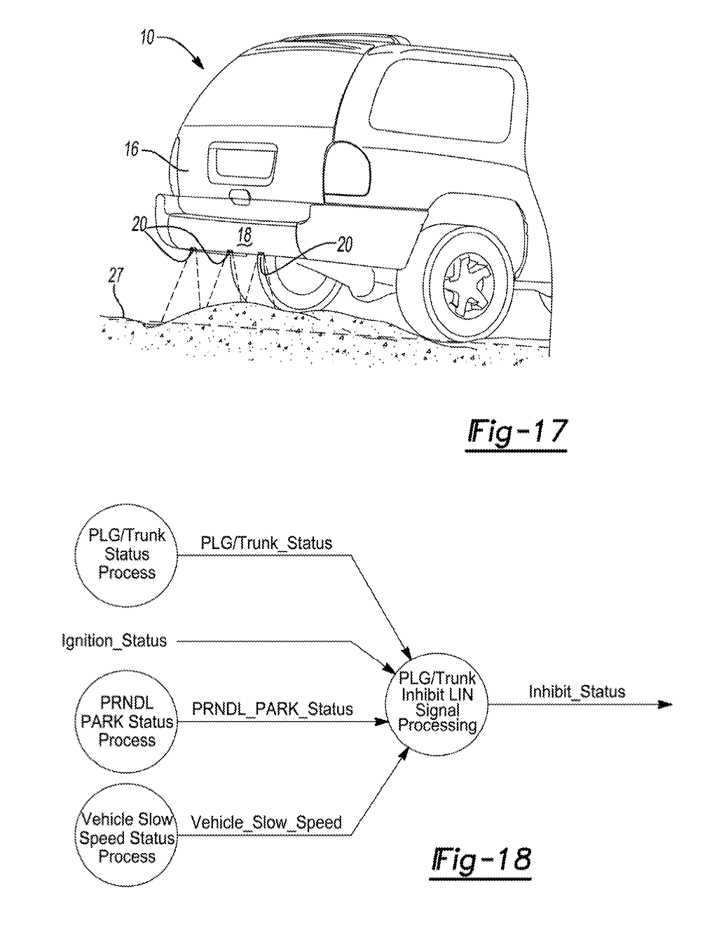

Additional operation signals may also be received by the electronic control unit 32, such as those to inhibit movement of the closure member (e.g., rear liftgate 14). Such inhibiting may be done, for example, if the vehicle 12 is not in park and for safety reasons, it is necessary to prevent operation of the rear liftgate 14. In such a case, the electronic control unit 32 is further configured to receive at least one inhibit signal of the plurality of operational signals, as shown in FIG. 18 and may also be configured to determine an inhibition status based on at least one inhibit signals received.

The electronic control unit 32 can also be configured to determine whether a battery voltage is a normal voltage based on an input supply voltage (e.g., the battery connection to the electronic control unit 32). The electronic control unit 32 is also configured to enter a sleep mode based on communication with the plurality of vehicle controllers and the expiring of a sleep timer. According to an aspect, the electronic control unit 32 will enter sleep mode when the Master LIN node enters sleep mode; that is the Master Node is no longer sending out the LIN messages on the bus. When electronic control unit 32 detects that the LIN bus is in idle state, the LIN stack will set the LIN bus to sleep after approximately 10 seconds. The electronic control unit 32 will enter sleep mode approximately 10 seconds after LIN bus is set to sleep mode. The total time to enter sleep mode approximately 20 seconds. While in the sleep mode, the electronic control unit 32 may require less electrical current (e.g., approximately 100 uA). However, other sleep or low power modes may alternatively be utilized.

Accordingly, the disclosed object detection system 10 increases foot detection area compared to existing ultrasonic solutions. This reduces the number of ultrasonic transducers 20 to cover an area of detection. The system 10 also allows the distance between the ultrasonic transducers 20 and the reference surface to be reduced, while still allowing foot detection. This opens up applications on low clearance vehicles 12 such as sedans, and sports cars. The system 10 also can dynamically adapt to the surface distance from the ultrasonic transducers 20. This allows the system 10 to provide versatility and adaptability to different environments and parking situations. Specifically, the system 10 adapts to variable surfaces below the ultrasonic transducers 20 to properly establish a baseline by avoiding false reference points.

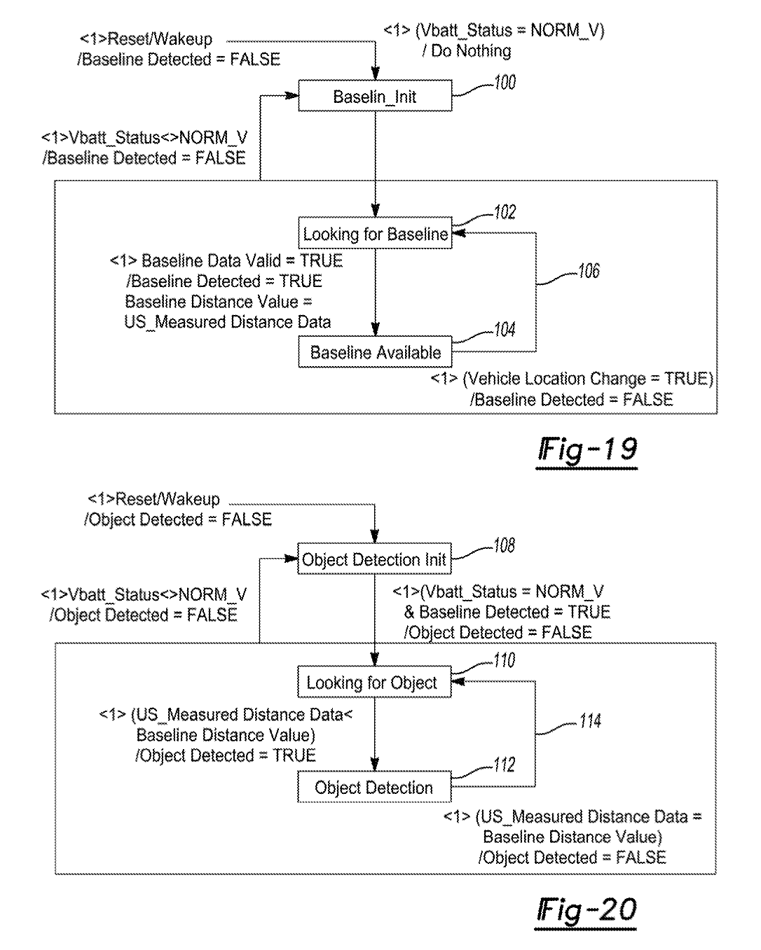

As best shown in FIGS. 19-21 it is another aspect of the present disclosure to provide a method of operating an ultrasonic object detection system 10 for user-activation of a power closure member system to move a vehicle closure member (e.g., rear liftgate 14) of a vehicle 12. The method can include the step of detecting a key fob 22 associated with the vehicle 12 within a predetermined distance of the vehicle 12 using one of a plurality of vehicle controllers of the vehicle 12 (e.g., a keyless entry system of the vehicle 12) to output a valid key fob signal of a plurality of operational signals.

The method can also include the steps of receiving at least one inhibit signal of the plurality of operational signals and determining an inhibition status based on the at least one inhibit signals received. The method may also include the step of determining whether a battery voltage is a normal voltage based on an input supply voltage. The step of determining whether a battery voltage is a normal voltage based on an input supply voltage can include the step of establishing one of an under voltage fault and an over voltage fault based on the input supply voltage. Such voltage faults will have a mature time and de-mature time associated with the fault setting and restoration. The operational range of the electronic control unit 32 may, for example, be from 10 to 16 V. If out of this range, the indicator 28 can be configured to flash every second to alert the user 23 of this condition.

The method includes the step of detecting a change in the state, such as the location, of the vehicle 12 with one of a plurality of vehicle controllers of the vehicle 12 to output a vehicle state change signal, such as a vehicle location change signal, of the plurality of operational signals. The method continues by determining a baseline setting (i.e., entering a calibration mode of the electronic control unit 32) for at least one ultrasonic transducer 20 based on a distance to a ground surface in response to receiving the vehicle state change signal, such as the vehicle location change signal.

More specifically, as best shown in FIG. 19, the step of determining a baseline setting for at least one ultrasonic transducer 20 based on a distance to a ground surface in response to receiving the vehicle location change signal can include the step of 100 entering a baseline initialization state in response to the battery voltage being a normal voltage and receiving a wakeup signal. The step of determining a baseline setting for at least one ultrasonic transducer 20 can also include 102 searching for the baseline setting for the at least one ultrasonic transducer 20 and 104 establishing the baseline setting for the at least one ultrasonic transducer 20 once the baseline setting is available. In addition, the step of determining a baseline setting for at least one ultrasonic transducer 20 can include 106 returning to the step of 102 searching for the baseline setting for the at least one ultrasonic transducer 20 in response to receiving the vehicle location change signal. Consequently, after each movement of the vehicle 12, and the vehicle 12 being moved into a parked state or mode, the system 10 is recalibrated to determine the baseline of the ground using both the sweeping configuration to determine the height differences between the at least one ultrasonic transducer 20 and the ground below the at least one ultrasonic transducer 20, and/or also any variations below a single ultrasonic transducer 20 using a dual transducer configuration to establish the true baseline.

The next step of the method is notifying a user to present a gesture using an indicator 28 electrically coupled to the electronic control unit 32 and disposed on a vehicle body 16 of the vehicle 12. The method proceeds by detecting an activation gesture made by the user 23 with the at least one ultrasonic transducer 20. In more detail, as best shown in FIG. 20, the step of detecting an activation gesture made by the user 23 with the at least one ultrasonic transducer 20 can include the step of 108 entering an object detection state in response to the battery voltage being a normal voltage and receiving a wakeup signal. The step of detecting an activation gesture made by the user 23 can additionally include the steps of 110 operating the at least one ultrasonic transducer 20 as a transmitter of a plurality of ultrasonic bursts 24 and a receiver of a plurality of ultrasonic echoes 25 to determine a measured distance value using the at least one ultrasonic transducer 20 and comparing the measured distance value to the baseline setting for the at least one ultrasonic transducer 20. The step of detecting an activation gesture made by the user 23 can also include 112 establishing detection of the activation gesture in response to the measured distance value being less than the baseline setting and 114 returning to the step of 110 operating the at least one ultrasonic transducer 20 in response to the measured distance value being equal to the baseline setting.

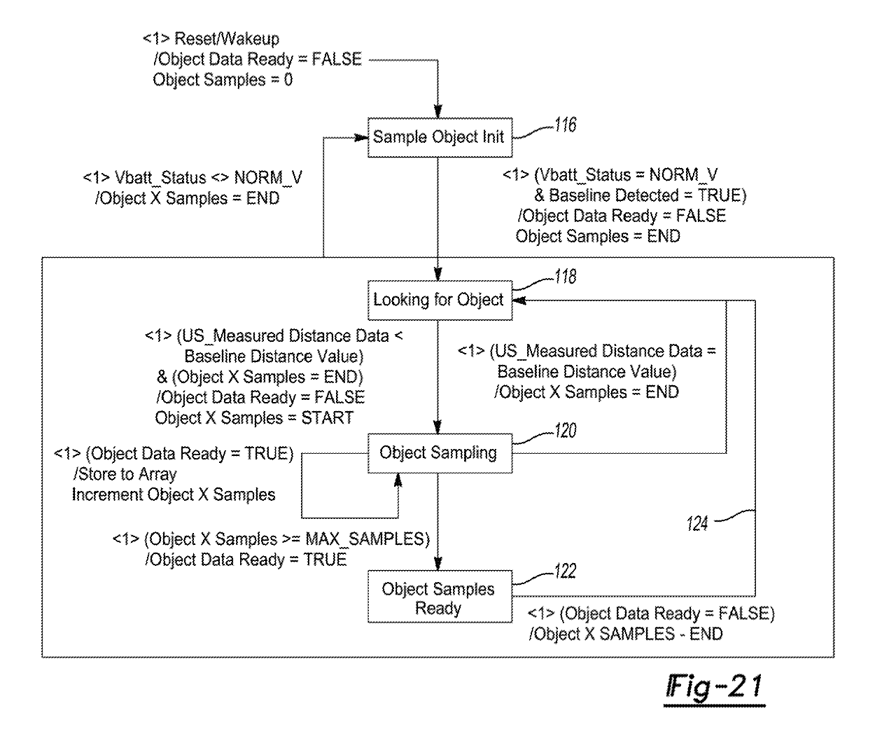

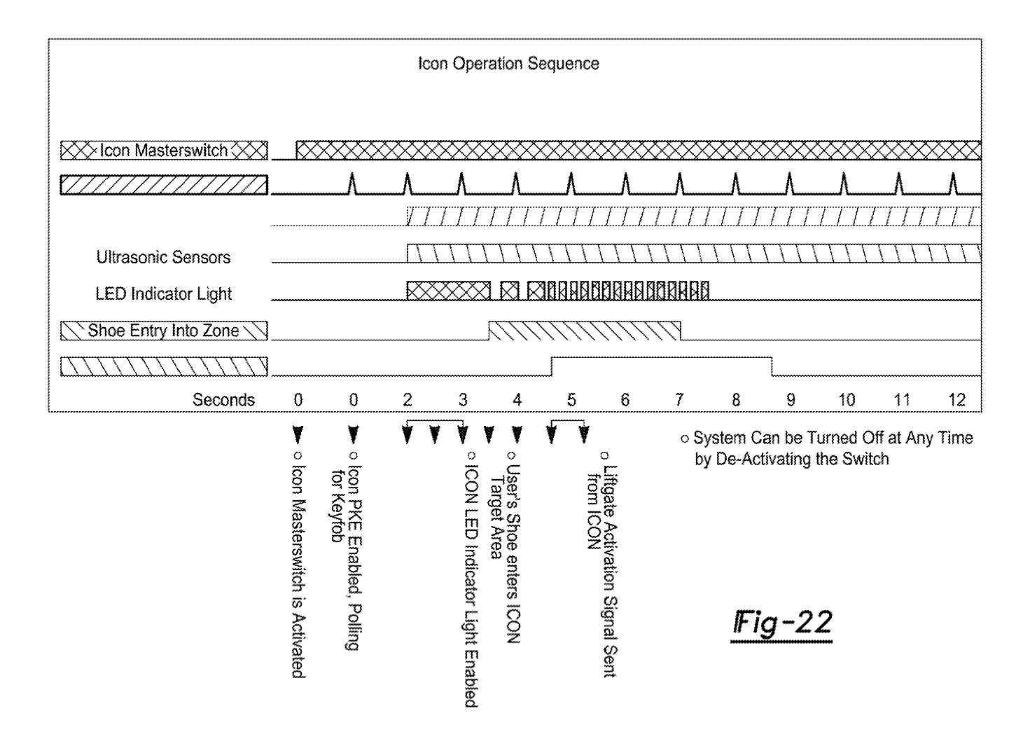

As best shown in FIG. 21, the step of detecting an activation gesture made by the user 23 with the at least one ultrasonic transducer 20 can additionally include the step of 116 entering an object detection state in response to the battery voltage being a normal voltage and receiving a wakeup signal. The step of detecting an activation gesture made by the user 23 can also include 118 sequentially operating the plurality of ultrasonic transducers 20 as a transmitter of a plurality of ultrasonic bursts and a receiver of a plurality of ultrasonic echoes 25 to determine a plurality of measured distance values using the plurality of ultrasonic transducers 20. The step of detecting an activation gesture made by the user 23 can also include the steps of 120 sampling the plurality of measured distance values and comparing the samples of the plurality of measured distance values to the baseline setting for each of the plurality of ultrasonic transducers 20 and 122 establishing readiness of the samples in response to the measured distance value being less than the baseline setting. The step of detecting an activation gesture made by the user 23 may also include the step of 124 returning to the step of 118 sequentially operating the plurality of ultrasonic transducers 20 in response to the samples not being ready. So, for example, the object can be sampled every 20 ms for 25 samples, if the valid object is detected (i.e., all samples are within 10 mm tolerance). Then the object distance is compared to the established baseline setting. When the difference is greater than 5 cm and the object distance must be less than the baseline, then the object is considered to be active. Once the object or gesture has been detected, the method can further include validating the object.

The method also includes the step of transmitting an activation signal to the plurality of vehicle controllers to move the closure member (e.g., rear liftgate 14) in response to detecting the activation gesture. The method concludes with the step of altering the indicator 28 based on the detection of the activation gesture and movement of the closure member. FIG. 22 illustrates an overall operation timing sequence of the disclosed ultrasonic object detection system 10, for example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. An ultrasonic object detection system for a motor vehicle including a vehicle body and a closure member attached to the vehicle body, the system comprising:
at least one ultrasonic transducer attached to the vehicle body for selectively outputting a plurality of ultrasonic bursts and receiving a plurality of the ultrasonic echoes;
an electronic control unit including at least one ultrasonic driver electrically coupled to the at least one ultrasonic transducer and in communication with at least one vehicle controller and configured to:
receive a plurality of operational signals from the at least one vehicle controller,
detect an activation gesture made by a user with the at least one ultrasonic transducer,
transmit an activation signal to the at least one vehicle controller in response to detecting the activation gesture made by the user for operating the closure member.

2. The system as set forth in claim 1, wherein the closure member is a liftgate and the at least one ultrasonic transducer includes a plurality of ultrasonic transducers attached to a rear bumper of the vehicle body.

3. The system as set forth in claim 2, wherein the electronic control unit is further configured to sequentially operate each of the plurality of ultrasonic transducers as a transmitter of the plurality of ultrasonic bursts and a receiver of the plurality of ultrasonic echoes.

4. The system as set forth in claim 2, wherein the electronic control unit is configured to operate each of the plurality of ultrasonic transducers as one of the transmitter of the plurality of ultrasonic bursts and the receiver of plurality of the ultrasonic echoes opposite the operation of an adjacent one of the plurality of ultrasonic transducers as one of the transmitter of the plurality of ultrasonic bursts and the receiver of plurality of the ultrasonic echoes.

5. The system as set forth in claim 1, wherein the plurality of operational signals includes a vehicle state change signal and the electronic control unit is configured to determine a baseline setting for the at least one ultrasonic transducer based on a distance to a ground surface in response to receiving the vehicle state change signal.

6. The system as set forth in claim 4, wherein the at least one ultrasonic transducer includes a plurality of ultrasonic transducers and the determination for the baseline setting is completed for each of the plurality of ultrasonic transducers as a function of the terrain below the vehicle.

7. The system as set forth in claim 1, wherein the electronic control unit is further configured to:
receive at least one inhibit signals of the plurality of operational signals; and
determine an inhibition status based on the at least one inhibit signals received.

8. The system as set forth in claim 1, further including an indicator attached to the vehicle body for informing the user of an appropriate location to make the activation gesture for initiating opening of the closure member of the vehicle, wherein the least one ultrasonic transducer attached to the vehicle body is oriented for selectively outputting the plurality of ultrasonic bursts towards the appropriate location.

9. The system as set forth in claim 8, wherein the indicator includes a housing defining a chamber and the at least one ultrasonic transducer is disposed in the chamber of the housing, wherein the indicator is oriented substantially horizontally to the ground and the at least one ultrasonic transducer is oriented to output the plurality of ultrasonic bursts substantially vertically towards the ground.

10. The system as set forth in claim 2, wherein the at least one ultrasonic transducer is oriented to output the plurality of ultrasonic bursts substantially beneath the rear bumper.

11. The system as set forth in claim 1, wherein the vehicle state change signal is representative of a vehicle state change selected from the group consisting of: a change in vehicle state from a drive state to a parked state, a change in vehicle state from a moving state to a stopped state, or a change in vehicle state from a moving state above a threshold speed to below a vehicle threshold speed; an expiry of a sleep timer.

12. A method of operating an ultrasonic object detection system for user-activation of a power closure member system to move a vehicle closure member of a vehicle comprising the steps of:
detecting a change in the state of the vehicle with one of a plurality of vehicle controllers of the vehicle to output a vehicle state change signal of a plurality of operational signals;
determining a baseline setting for at least one ultrasonic transducer based on a distance to a ground surface in response to receiving the vehicle state change signal;
detecting an activation gesture made by a user with the at least one ultrasonic transducer; and
transmitting an activation signal to the plurality of vehicle controllers to move the closure member in response to detecting the activation gesture.

13. The method as set forth in claim 12, further including the step of detecting a key fob associated with the vehicle within a predetermined distance of the vehicle using one of a plurality of vehicle controllers of the vehicle to output a valid key fob signal of a plurality of operational signals.

14. The method as set forth in claim 12, further including the steps of:
receiving at least one inhibit signal of the plurality of operational signals; and
determining an inhibition status based on the at least one inhibit signals received.

15. The method as set forth in claim 12, wherein the step of determining a baseline setting for at least one ultrasonic transducer based on a distance to a ground surface in response to receiving the vehicle state change signal includes the steps of:
searching for the baseline setting for the at least one ultrasonic transducer;
establishing the baseline setting for the at least one ultrasonic transducer once the baseline setting is available; and
returning to the step of searching for the baseline setting for the at least one ultrasonic transducer in response to receiving the vehicle state change signal.

16. The method as set forth in claim 12, wherein the step of detecting an activation gesture made by the user with the at least one ultrasonic transducer includes the steps of:
operating the at least one ultrasonic transducer as a transmitter of a plurality of ultrasonic bursts and a receiver of a plurality of ultrasonic echoes to determine a measured distance value;
comparing the measured distance value to the baseline setting for the at least one ultrasonic transducer;
establishing detection of the activation gesture in response to the measured distance value being less than the baseline setting; and
returning to the step of operating the at least one ultrasonic transducer in response to the measured distance value being equal to the baseline setting.

17. The method as set forth in claim 12, wherein the at least one ultrasonic transducer includes a plurality of ultrasonic transducers and wherein the step of detecting an activation gesture made by the user with the at least one ultrasonic transducer includes the steps of:
sequentially operating the plurality of ultrasonic transducers as a transmitter of a plurality of ultrasonic bursts and a receiver of a plurality of ultrasonic echoes to determine a plurality of measured distance values;
sampling the plurality of measured distance values;
comparing the samples of the plurality of measured distance values to the baseline setting for each of the plurality of ultrasonic transducers;
establishing readiness of the samples in response to the measured distance value being less than the baseline setting; and
returning to the step of sequentially operating the plurality of ultrasonic transducers in response to the samples not being ready.

18. The method as set forth in claim 17, wherein the step of sequentially operating the plurality of ultrasonic transducers as a transmitter of a plurality of ultrasonic bursts and a receiver of a plurality of ultrasonic echoes to determine a plurality of measured distance values includes the step of operating the plurality of ultrasonic transducers as a receiver of a plurality of ultrasonic echoes after the plurality of ultrasonic transducers as a receiver of a plurality of ultrasonic echoes have reached a stable ringing state.

19. The method as set forth in claim 15, wherein the step of searching for the baseline setting for the at least one ultrasonic transducer includes sequentially operating the plurality of ultrasonic transducers as a transmitter of a plurality of ultrasonic bursts and a receiver of a plurality of ultrasonic echoes to determine a plurality of measured distance values.

20. An ultrasonic object detection system for a motor vehicle including a vehicle body and a closure member attached to the vehicle, the system comprising:
a housing attachable to the vehicle;
at least two ultrasonic transducers disposed within the housing for selectively outputting a plurality of ultrasonic bursts towards a ground surface about a perimeter of the vehicle and receiving a plurality of the ultrasonic echoes; and
an electronic control unit disposed within the housing and including at least two ultrasonic driver electrically coupled to the at least two ultrasonic transducers and in communication with at least one vehicle controller and configured to:
sequentially operate each of the at least two ultrasonic transducers as a transmitter of the plurality of ultrasonic bursts and a receiver of the plurality of ultrasonic echoes, and
detect an activation gesture made by a user with the at least two ultrasonic transducers, and
transmit an activation signal to the at least one vehicle controller in response to detecting the activation gesture made by the user for operating the closure member.
